(19) United States
(12) Patent Application Publication
(10) Pub. No.: US 2024/0375888 A1
(43) Pub. Date: Nov. 14, 2024

(54) GRIPPING DEVICE FOR GRIPPING A CONTAINER, AND HOLDING APPARATUS COMPRISING A GRIPPING DEVICE

(71) Applicant: Bausch + Stroebel SE + Co. KG, Ilshofen (DE)

(72) Inventors: Andreas Boehmike, Ilshofen (DE); Steffen Heier, Ilshofen (DE); Klaus Kaiser, Ilshofen (DE); Daniel Spieler, Ilshofen (DE); Sebastian Faerber, Ilshofen (DE); Manuel Wallisch, Ilshofen (DE)

(21) Appl. No.: 18/781,718

(22) Filed: Jul. 23, 2024

Related U.S. Application Data
(63) Continuation of application No. PCT/EP2023/051817, filed on Jan. 25, 2023.

(30) Foreign Application Priority Data
Jan. 28, 2022 (DE) 10 2022 102 012.6

(51) Int. Cl. B65G 47/90; B65B 43/46

(52) U.S. Cl. CPC B65G 47/907; B65B 43/46; B65G 2201/0235

(57) ABSTRACT

A gripping device for gripping a pharmaceutical container, in particular a pharmaceutical container which is non stable, includes a first gripping element and a second gripping element, each gripping element having a respective gripping member for contacting the container in particular from opposite sides. The gripping elements receive the container between one another in a container receptacle and grip the container in a mutually approximated gripping position, and release the container in a mutually spaced release position. At least one gripping element comprises two gripping members which are mutually spaced apart in a spacing direction, and between which a recess is formed on the gripping element. A holding device includes at least one gripping device.

### CROSS-REFERENCE TO RELATED APPLICATIONS

This application is a continuation of International Application No. PCT/EP2023/051817, filed on Jan. 25, 2023, and claims priority to German Application No. 10 2022 102 012.6, filed on Jan. 28, 2022. The contents of International Application No. PCT/EP2023/051817 and German Application No. 10 2022 102 012.6 are incorporated by reference herein in their entireties.

### FIELD

The present disclosure relates to a gripping device for gripping an in particular non stable pharmaceutical container, for example in a machine for processing containers.

The present disclosure additionally relates to a holding apparatus having such a gripping device.

### BACKGROUND

In a machine for processing containers, the containers run through different types of processing stations (which can also be referred to as processing devices), for example, from an inlet to an outlet. For example, the containers supplied via the inlet are first weighed, then filled, weighed again, sealed, and coupled out via the outlet. The containers can in particular be pharmaceutical containers, such as syringes, carpules, ampules, and/or vials. In the present case, “containers” can also comprise other types of packaging means, such as cosmetic containers.

For holding the containers, for example for “temporary parking” and/or during transport, the machine can comprise a holding apparatus with a gripping device in which gripping elements receive and hold the container between them in a gripping position. For this purpose, the gripping elements form a container receptacle, for example. The gripping elements can assume a release position in which the container receptacle is released, for example for placing the container on a set-down element and/or during the transfer of the container to a fixing device in which the containers can be held in a force-locking and/or positive-locking manner, for example. Conversely, the containers can be received by the set-down element or removed from the fixing device when the gripping elements are transferred into the gripping position and placed against the container.

Such a gripping device and a holding apparatus which is used for transport purposes are described, for example, in DE 10 2018 213 800 A1.

Among containers there are so-called stable containers, for example vials which can be set down on a set-down element, and also so-called non stable containers. Due to their geometry, these cannot stand upright of themselves which is why they must be fixed in a fixing device by force-locking and/or positive-locking, for example. Non stable containers include, for example, syringes (including any needle guard), carpules or ampules, with other types of packaging also being conceivable.

### SUMMARY

The object of the present disclosure is to provide a gripping device for an in particular pharmaceutical container with which in particular non stable containers can be reliably gripped. In addition, the object of the present disclosure is to provide a holding apparatus with at least one such gripping device.

The object is achieved by a gripping device in accordance with the present disclosure for gripping an in particular non stable pharmaceutical container, comprising a first gripping element and a second gripping element, each having a respective gripping member for contacting the container in particular from opposite sides, wherein the gripping elements receive the container between one another in a container receptacle and grip the container in a mutually approximated gripping position and in a mutually spaced-apart release position release the container, wherein at least one gripping element comprises two gripping members which are mutually spaced apart in a spacing direction and between which a recess is formed on the gripping element.

In the gripping device in accordance with the present disclosure, the container defining a container direction can in particular be held in the container receptacle when the gripping elements are in the gripping position in such a way that the container direction coincides with or runs parallel to the spacing direction. At least one gripping element comprises two gripping members spaced apart in the spacing direction, via which the container can preferably be subjected to a holding force. A recess is formed between the gripping members relative to the spacing direction. For example, a fixing device for force- and/or positive-locked fixing of the container can engage in the recess when the container is transferred to the fixing device or removed therefrom. In this case, the fixing device engages in the recess transversely and in particular perpendicularly to the spacing direction. Due to the two gripping members, the container is expediently secured in the container receptacle in such a way that during transfer to the fixing device and/or during removal from the fixing device, a tilting of the container in the gripping device can be prevented. In this way, for example, the process reliability in a machine for processing the containers can be improved.

The gripping device in accordance with the present disclosure proves to be particularly advantageous for use with non stable containers which, for example, can be fixed suspended via the fixing device. Use with stable containers is also conceivable.

The gripping device can, for example, be used with a fixing device as described in the patent application with the application number DE 10 2022 101 994.2 by the same applicant with the same filing date of 28 Jan. 2022 and the title “Holding device for a container and device for processing containers”. The disclosure of this patent application is incorporated in its entirety into the present patent application.

In an exemplary embodiment of the gripping device in accordance with the present disclosure, it can be provided that one of the gripping elements can comprise only one gripping member, whereas the other gripping element, as explained, comprises two gripping members spaced apart from one another so that the container can be held via three gripping members. The first-mentioned gripping member can for example be arranged, relative to the spacing direction, in the region of the recess between the two last-mentioned gripping members, preferably centrally between these two gripping members.

It can be advantageous if each gripping element comprises two gripping members which are spaced apart from one another in the spacing direction and between which a recess is formed on the respective gripping element. In this way, the container can be held more reliably with the gripping device and preferably secured against tilting.

Along the spacing direction, a gripping member of the first gripping element and a gripping member of the second gripping element are preferably arranged at the same position, whereby the container can preferably be subjected to a holding force, with respect to the spacing direction, at positions directly opposite one another.

It can be advantageous if two gripping members arranged in the spacing direction at the same position define a common contact plane and/or are planar in configuration. In the intended use of the gripping device, the two gripping members are arranged on the upper side, for example. The contact plane and/or planar design allow, for example, the abutment of a projection of the container. In this way, the container can be held in a defined position along the spacing direction. The projection is, for example, a finger flange of a syringe.

The first gripping element preferably comprises two identically configured gripping members.

Alternatively or additionally, the second gripping element comprises two identically configured gripping members.

A distance of the gripping members from one another along the spacing direction can, in a preferred exemplary embodiment of the present disclosure, be for example approximately 1 cm to 6 cm, preferably approximately 2 cm to 5 cm.

In relation to a side view, for example in a plane transverse and in particular perpendicular to the spacing direction, the gripping element comprising at least two gripping members is configured to be substantially C-shaped, for example, at least in portions. A respective leg of the C forms, for example, a gripping member, wherein the recess is arranged in between. In particular, both gripping elements can be substantially C-shaped in the side view.

The container receptacle preferably comprises a concave recess on the gripping member of at least one gripping element, into which the container engages in the gripping position, preferably on the gripping members of both gripping elements.

For example, it can be provided that the at least one gripping member of the first gripping element and the at least one gripping member of the second gripping element can be configured to be symmetrical to one another relative to a central plane of the gripping device. In this case, a concave recess is preferably arranged or formed on each gripping member. The gripping members of the above-described embodiment can be configured to be identical in shape and function and mirror-symmetrical to one another.

In a different preferred embodiment of the present disclosure, it can be provided that the gripping members can be configured differently from one another, and with no symmetry between the gripping members in particular relative to a central plane of the gripping device.

In a preferred embodiment of the present disclosure, it is provided that, for example, the at least one gripping member of the first gripping element and the at least one gripping member of the second gripping element in each case can have substantially the shape of an L forming the container receptacle with two legs each of which are configured to be abutted against the container, wherein in particular two legs in each case lie opposite one another at the first gripping element and at the second gripping element. The above statement relates in particular to a plan view of the gripping elements along the spacing direction. A respective gripping member can substantially be L-shaped and comprise two legs oriented at an angle to one another. A leg of a gripping member preferably lies opposite a leg of the gripping member of the other gripping element.

An angle between the legs of the L is, for example, approximately 80° to 120°, preferably approximately 100° to 110°.

The respective gripping element can, for example, have a first side and a second side. Via the first side, on which, for example, a holding portion is arranged, the gripping element can be held on a holding part of the holding apparatus, for example. The gripping member can, for example, be arranged on the second side. The gripping member can, for example, have a free end.

It can be advantageous if the at least one gripping member of the first gripping element comprises a projection projecting in the direction of the other gripping element at a free end and projects from a lateral support portion of the gripping member. The projection can, for example, engage behind the container held in the container receptacle and abut against the container. The lateral support portion can abut laterally against the container.

The projection preferably forms a stop for the container for applying a tensile force. This tensile force is exerted on the container, for example, in order to remove it from the above-described fixing device.

In particular, it is possible for there to be no projection applying tensile force to the container arranged on the second gripping element.

The first gripping element can, for example, be configured to be plate-shaped, wherein the projection projects beyond the plane of the gripping element in the direction of the other gripping element. For example, in an approached gripping position, the projection can project beyond the central plane of the gripping element in the direction of the other gripping element.

The second gripping element can recede behind the projection at the free end. This can be understood in particular to mean that the second gripping element is configured shorter on the second side than is the first gripping element with the projection. As a result, the gripping elements can be transferred into a gripping position in which they are so closely adjacent that even containers of a small diameter can be gripped with the gripping device.

The projection and the lateral support portion of the gripping member of the first gripping element form, for example, the L-shape of the gripping member, as explained above.

It can be advantageous if the at least one gripping member of the second gripping element comprises a projection projecting in the direction of the other gripping element in front of the free end and a lateral support portion arranged at the free end. The projection can be located in front of the free end of the container, and the lateral support portion can abut laterally against the container.

The projection preferably forms a stop for the container for applying a pushing force. The pushing force is exerted on the container, for example, in order to insert it into the above-described fixing device.

In particular, it can be provided that no projection applying pushing force to the container is arranged on the second gripping element.

The second gripping element is configured, for example, plate-shaped, wherein the projection projects beyond the plane of the gripping element in the direction of the other gripping element. In an approached gripping position of the gripping elements, the projection can project, for example, beyond a central plane of the gripping element in the direction of the other gripping element.

A recess, for example, is formed opposite the projection on the first gripping element. This offers the possibility that the projection can engage in the recess in an approached gripping position. This allows even containers having a small diameter to be reliably gripped with the gripping device.

The projection and the lateral support portion of the gripping member of the second gripping element form, for example, the L-shape, as explained above.

The gripping elements preferably each comprise a gripping portion comprising the at least one gripping member and a holding portion via which the gripping element is fixed or fixable to a particular holding part. In this case, for example, a positive-and/or force-locking fixing of the gripping elements on the corresponding holding part is provided.

The holding portions are preferably arranged at different positions relative to the spacing direction. During intended use, the holding portions are arranged, for example, one above the other. In this way, the gripping device has a compact design.

The respective holding portion can, for example, be configured C-shaped, in particular in a side view transversely and in particular perpendicular to the spacing direction. In this way, the holding portion can, for example, surround an elongated holding part and can be fixed thereto in a force-locking and/or positive-locking manner.

As already mentioned, the present disclosure also relates to a holding apparatus. A holding apparatus in accordance with the present disclosure, which achieves the object mentioned at the outset, for an in particular non stable pharmaceutical container comprises a first holding part and a second holding part and at least one gripping device of the above-described type, wherein the first gripping element is fixed via a holding portion on the first holding part, and the second gripping element is fixed via a holding portion on the second holding part.

The advantages already mentioned in connection with the explanation of the gripping device in accordance with the present disclosure can also be achieved with the holding apparatus. In this regard, reference can be made to the above statements.

Advantageous embodiments of the holding apparatus in accordance with the present disclosure result from advantageous embodiments of the gripping device in accordance with the present disclosure.

The gripping elements can, for example, be fixed to the particular holding part by force- and/or positive-locking via the holding portion. A latching and/or clamping connection is conceivable, for example.

The respective gripping element is advantageously detachably fixed to the respective holding part. This offers the possibility of connecting different gripping devices to the holding parts depending on the containers to be processed. Each gripping device preferably covers a specific format range of containers with regard to container size and/or container type. By exchanging the gripping device, a different format range can be covered.

The connection of the gripping elements to the holding parts and/or optionally their release from the holding parts is preferably possible manually and/or without tools.

In a preferred embodiment, the holding apparatus can comprise a plurality of preferably identically configured gripping devices with respective gripping elements fixed to the holding parts. The gripping devices are preferably arranged laterally next to one another along an extension direction of the holding parts. The gripping devices are preferably positioned equidistantly. A plurality of containers can be held simultaneously by the holding apparatus via the plurality of gripping devices, and the processing clock time can thereby be increased.

The holding apparatus preferably comprises a respective anti-rotation member associated with the gripping element, which is in engagement with the holding part and the gripping element. In this way, a defined position of the gripping element on the holding part can be assumed in a structurally simple manner. For example, the gripping element is in positive-locking engagement with the holding part via a C-shaped holding portion. A pin-shaped anti-rotation member, for example, can prevent a rotation of the gripping element relative to the holding part.

The holding parts are preferably configured to be elongated. For example, the holding parts are solid bodies; they can alternatively be configured as hollow bodies in order to achieve low masses and torques, for example as tubes or as (hollow) strips.

The holding apparatus can comprise a drive unit via which the holding parts can be moved relative to one another in a linear direction. By moving the holding parts relative to one another, the gripping elements can be transferred from the gripping position into the release position and vice versa by changing the distance of the gripping elements from one another in each case. The holding parts can preferably be moved independently of one another along the linear direction via the drive unit.

The holding parts are preferably movable together via the drive unit in a direction oriented transversely and in particular perpendicularly to the linear direction. As a result, the containers in the gripping elements can be moved in particular in a feed direction up to the above-described fixing device and transferred thereto and in the opposite direction for removal away from the fixing device.

The drive unit can, for example, be configured as described in DE 10 2018 213 800 A1 in order to achieve the movement in the linear direction and transversely and in particular perpendicularly thereto.

### BRIEF DESCRIPTION OF THE DRAWINGS

The following description of preferred embodiments of the present disclosure serves in conjunction with the drawing to explain the present disclosure in more detail. In the figures:

FIG. 1: shows a schematic representation of a holding apparatus in accordance with the present disclosure with gripping devices in accordance with the present disclosure, in each case in a preferred embodiment;

FIG. 2: shows a perspective partial view of the holding apparatus from FIG. 1, wherein the gripping devices for holding containers assume a particular gripping position;

FIG. 3: shows a perspective view of the gripping device in accordance with the present disclosure of the holding apparatus;

FIG. 4: shows a side view of the partial representation of the holding apparatus in the viewing direction of the arrow “4” in FIG. 2, partially cut away, and a fixing device for the containers;

FIG. 5: shows a sectional view along line 5-5 in FIG. 4 in an enlarged view;

FIG. 6: shows a view corresponding to FIG. 5, wherein the container held in the gripping element differs in size from the container in FIG. 5;

FIG. 7: shows a view in the viewing direction of the arrow “7” in FIG. 4, partially cutaway, showing the insertion of two containers into the fixing device by means of the holding apparatus; and

FIG. 8: shows a view corresponding to FIG. 7 with containers held in the fixing device and after transfer of the gripping elements into a release position.

### DETAILED DESCRIPTION

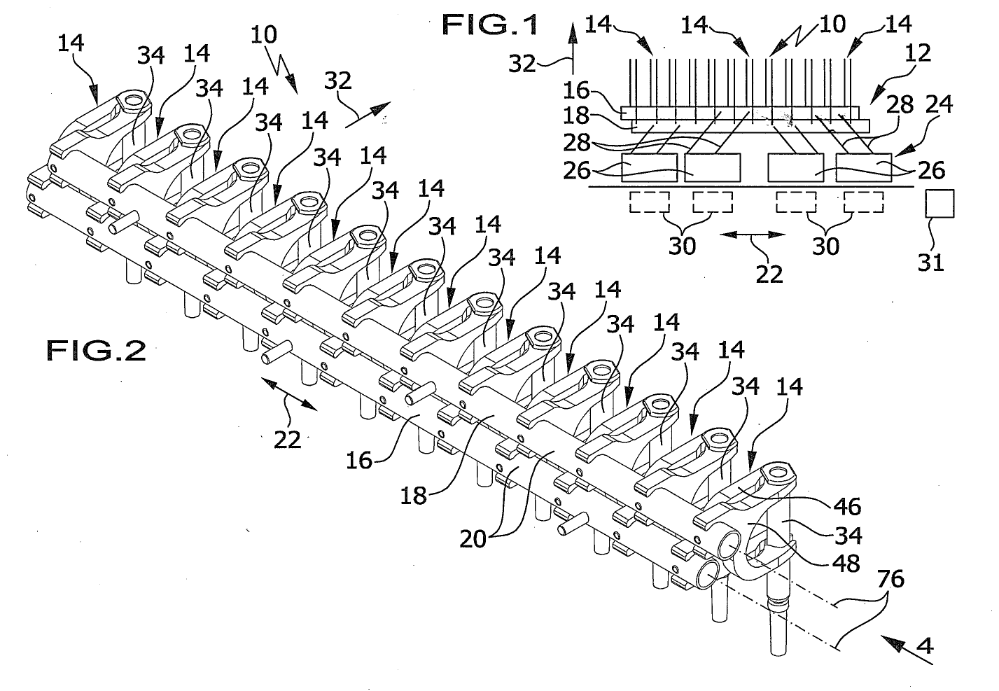

FIG. 1 shows a schematic view of an advantageous embodiment of the holding apparatus in accordance with the present disclosure, denoted overall by the reference numeral 10, which in the present exemplary embodiment is configured as a transport device 12.

The holding apparatus 10 comprises at least one gripping device 14 in accordance with the present disclosure in a preferred embodiment. In the present case, a total of twelve gripping devices 14 are provided which are configured in particular identically and whose number could also be different.

The holding apparatus 10 comprises a first holding part 16 and a second holding part 18. In the present example, the holding parts 16, 18 are configured to extend longitudinally, in particular as hollow bodies. In this case, the holding parts 16, 18 are, for example, tubes 20. The holding parts 16, 18 can be moved relative to one another along a linear direction 22 in both orientations. For this purpose, the holding apparatus 10 comprises a drive unit 24 with respective drive elements 26 which are connected to the holding parts 16, 18 via coupling elements 28.

The holding parts 16, 18 are advantageously movable along the linear direction 22 independently of one another via the drive unit.

The drive elements 26 can be self-moving. Alternatively or additionally, the drive elements 26 can be moved via, for example, magnetically drivable transport elements 30. The transport elements 30 are mounted, for example, on a transport path so as to be displaceable independently of one another, whereby an independent movement of the drive elements 26, which can be magnetically coupled to a respective transport element 30, is also possible.

The drive unit is preferably controllable by an electronic control unit 31.

The functional principle of the drive unit 24 is described in DE 10 2018 213 800 A1, to which reference is made in this context.

By means of the relative movement of the holding parts 16, 18 along the linear direction 22, there is the possibility of moving the holding parts 16, 18 together in a feed direction 32. The feed direction 32 is transverse and in particular perpendicular to the linear direction 22. This form of movement is also described in the above-mentioned document.

A container 34 can be gripped and in particular held via a respective gripping device 14. In the present case, the containers 34 are pharmaceutical containers, in particular syringes 36. The syringe 36 comprises a syringe body 38: on the top, a finger flange 40 and on the bottom, a needle guard 42. The syringe 36 defines a container direction 44.

Since the gripping devices 14 are configured identical in the present case, only the construction of one gripping device 14 will be discussed below. The explanations in this regard apply to the other gripping devices 14 in the same manner.

Along the linear direction 22, the gripping devices 14 are fixed equidistantly to the holding parts 16, 18.

As can be seen in particular from FIGS. 2 to 4, the gripping device 14 in accordance with the present disclosure comprises a first gripping element 46 and a second gripping element 48.

The gripping elements 46, 48 are preferably each manufactured in one piece (monolithic). In particular, production from a pharmaceutical material, for example from plastic, is advantageous. For example, POM (polyoxymethylene) or PEEK (polyether ether ketone) is used in this case.

The gripping elements 46, 48 are fixed laterally next to one another along the linear direction 22 on the holding parts 16, 18. In this case, the first gripping element 46 is held on the first holding part 16, and the second gripping element 48 is held on the second holding part 18.

If the holding parts 16, 18 are moved relative to one another, the distance of the gripping elements 46, 48 from one another can be changed. This makes it possible, in particular, for the gripping elements 46, 48 to assume a gripping position closer to each other (FIGS. 2 and also 5 to 7). In the gripping position, the container 34 is received in a container receptacle 50 between the gripping elements 46, 48 and is held thereby.

Furthermore, the gripping elements 46, 48 can be transferred into a release position (FIG. 8) in which the spacing is increased in relation to the gripping position. The container 34 is released and can be removed from the container receptacle 50 or conversely inserted into it.

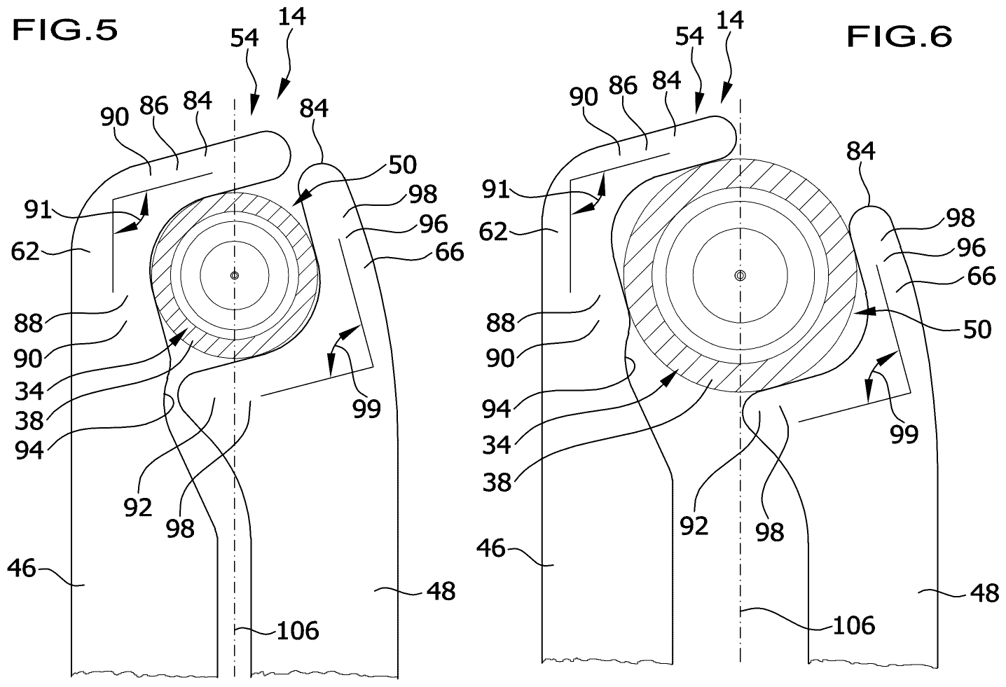

The gripping device 14 is designed such that the gripping elements 46, 48 each cover a format range of containers 34 which differ with regard to their size. For example, FIGS. 5 and 6 show two containers 34 of different sizes, in particular different diameters, each configured as syringes 36. In this way, the holding apparatus 10 and the gripping device 14 prove to be versatile. The versatility is also further increased by the gripping device 14 being releasably connectable to the holding parts 16, 18, which will be discussed below.

In the present case, the gripping elements 46, 48 are configured substantially plate-shaped. A plane defined by the gripping elements 46, 48 is oriented transversely and in particular perpendicularly to the linear direction 22.

Both gripping elements 46, 48 have a first side 52 which faces the holding parts 16 or 18, and a second side 54 which faces away from the holding parts 16 and 18.

Each gripping element 46, 48 comprises a holding portion 56 on the first side 52 and a gripping portion 58 which forms the second side 54.

The gripping portion 58 of the first gripping element 46 has two gripping members 62 which are spaced apart from one another in a spacing direction 60, and between which a recess 64 is formed. In the present example, the gripping portion 58 of the second gripping element 48 also has two gripping members 66 spaced apart from one another in the spacing direction 60. The gripping members 66 are also spaced apart from one another via the recess 64.

In a different advantageous embodiment of the present disclosure, one of the gripping elements 46, 48 can comprise two gripping members, but the other gripping element only have a gripping member which is arranged, for example, in the spacing direction 60, in particular centrally, between the two other gripping members.

In the intended use of the gripping device 14 when the container 34 is arranged between the gripping elements 46, 48, the spacing direction 60 coincides with the container direction 44 or is aligned parallel thereto.

Adjacent to the holding portion 56, the gripping portion 58 has a transition region 68 via which the gripping members 62 of the gripping element 46 or gripping members 66 of the gripping element 48 are connected to one another. In a side view along the linear direction 22 (transversely and in particular perpendicularly to the spacing direction 60), the gripping elements 46 are thereby configured to be partly substantially C-shaped (FIGS. 2 to 4).

Relative to the spacing direction 60, the gripping members 62 and the gripping members 66 are at the same position. The gripping members 62, 66 can be abutted against the container 34 from opposite sides in order to hold it.

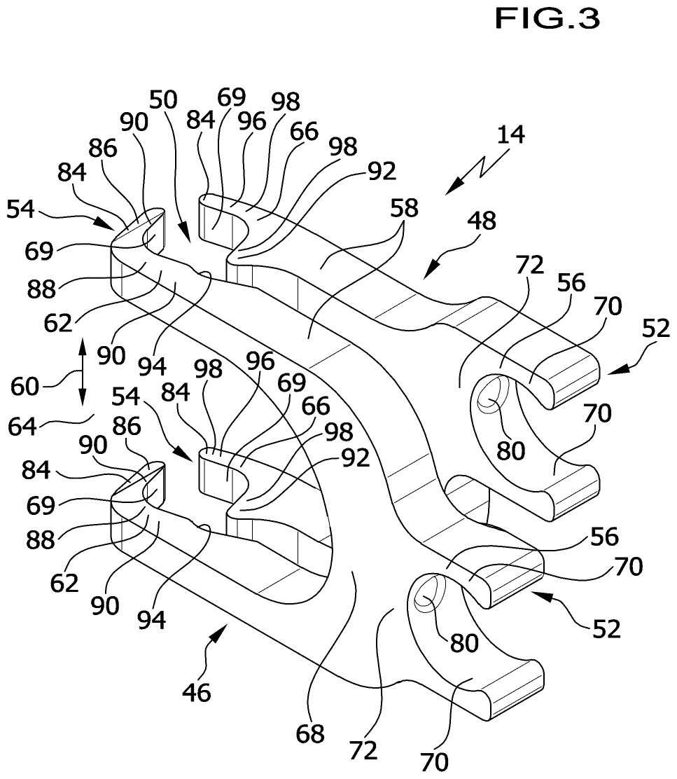

The container receptacle 50 comprises a concave recess 69 in the respective gripping member 62, 66, into which the container 34 engages when the gripping elements 46, 48 are in the gripping position (FIG. 3). The recesses 69 are preferably formed such that the containers 34 are centered in the gripping elements 46, 48.

In the present case, the respective holding portions 56 comprise two holding members 70 spaced apart from one another along the spacing direction 60. The holding members 70 are connected to one another at a transition region 72 which faces the gripping portion 58. At the holding portions 56, the gripping elements 46, 48 are substantially C-shaped in a side view along the linear direction 22.

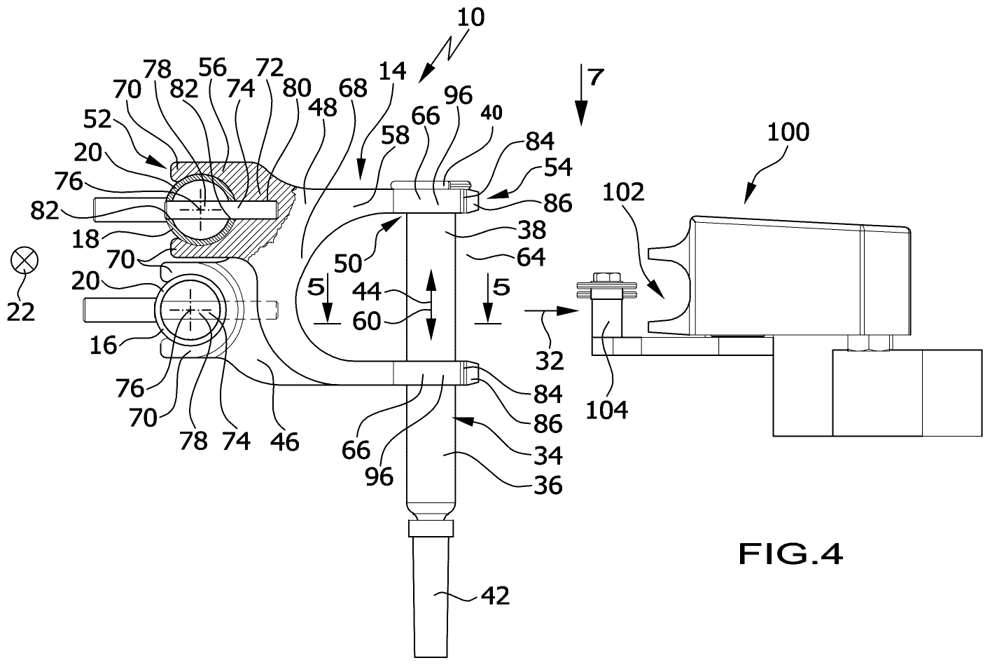

The gripping elements 46, 48 can be fixed in a positive-locking manner on the holding parts 16, 18 via the holding portions 56 (FIG. 4), wherein there is preferably also a force-locking connection. The holding members 70 can preferably be deformed relative to one another, as in the present example, so that the gripping elements 46, 48 can be snapped on, wherein the holding members 70 receive the holding part 16 or 18 between them.

A different design of the holding portions 56 for fixing the gripping elements 46, 48 to the holding parts 16, 18, in particular by positive- and/or force-locking connection, is conceivable.

The holding apparatus 10 comprises an anti-rotation member 74 associated with a particular gripping element 46, 48. A rotation of the gripping element 46, 48 on the holding part 16, or 18 about the axis 76 defined thereby, can be prevented via the anti-rotation member 74.

In the present example, the anti-rotation member 74 is configured as a pin 78 which engages in an opening 80 in the gripping element 46, 48 and in openings 82 in the holding part 16, 18 in a positive-locking manner. A different design of the embodiment of the anti-rotation device for the gripping elements 46, 48 is conceivable.

The gripping elements 46, 48 can be released from and connected to the holding part 16 or 18 manually and without tools, whereby the holding apparatus 10 has a user-friendly design.

The holding parts 16, 18 are arranged one above the other relative to the spacing direction 60. The same applies to the holding portions 56. In this case, the holding part 16 is arranged below the holding part 18, and the holding portion 56 of the gripping element 46 is below the holding portion 56 of the gripping element 48.

The design of the gripping members 62, 66 will be discussed below. In this case, the two gripping members 62 are of identical configuration. The same applies to the gripping members 66. For this reason, only the construction of one gripping member 62, 66 is described in each case, whereby the explanations also apply to the other gripping member.

As can be seen in particular from FIGS. 3 to 6, the gripping member 62 is finger-like in configuration and comprises a longitudinal extension in the direction of the second side 54. The gripping member 62 comprises a free end 84. At the free end 84, the gripping element 46 comprises a projection 86 in the direction of the gripping element 48. The projection 86 projects from a lateral support portion 88 of the gripping member 62.

The gripping member 66 recedes behind the projection 86 at its free end 84 (FIGS. 5 and 6) in that the gripping member 66 is configured shorter in the direction of the second side 54 than the gripping member 62.

In a plan view along the spacing direction 66, the gripping member 62 bordering the container receptacle 50 is substantially L-shaped. The legs 90 of the L are formed by the projection 86 and by the support portion 88 and border the recess 69. Both legs 90 can be placed laterally on the container 34.

An angle 91 between the legs 90 is in the present case approximately 80° to 120°, preferably approximately 100° to 110°.

The gripping member 66 is also finger-like in configuration in the direction of the second side 54 and has a longitudinal extension. The gripping member 66 comprises a projection 92 in front of the free end 84. The projection 92 projects beyond the plane of the gripping element 48 in the direction of the gripping element 46.

A recess 94 is formed opposite the projection 92 in the gripping element 46, in particular in the gripping member 62.

At the free end 84, the gripping member 66 comprises a lateral support portion 96. The support portion 96 projects beyond the projection 92.

In a plan view along the spacing direction 60, the gripping member 66 bordering the container receptacle 50 is formed substantially L-shaped. The legs 98 of the L are thereby formed by the projection 92 and by the support portion 96 and delimit the recess 69. Both legs 98 can be placed laterally on the container 34.

An angle 99 between the legs 98 is in the present case approximately 80° to 120°, preferably approximately 90° to 100°.

If the container 34 is arranged in the container receptacle 50 and held by the gripping elements 46, 48, a respective leg 90 lies opposite one of the legs 98. The container 34 can be supported, in particular on the syringe body 38, by the opposing support portions 88, 96 on the one hand, and by the mutually opposing projections 86 and 92 on the other hand.

In particular, the gripping members 62, 66 can each apply a holding force to the container 34 when the gripping elements 46, 48 assume the gripping position.

In the gripping position of the gripping elements 46, 48, the projection 92 can engage in the recess 94 (FIG. 5). At the same time, the projection 86 can project beyond the support portion 96 at the free end 84. This allows containers 34 of relatively small dimensions to also be held by the gripping device 14 in that the gripping elements 46, 48 assume a gripping position in which they are arranged close to one another.

In the case of sufficiently small containers 34, the projections 86, 92 project beyond a central plane 106 of the gripping device 14 in the direction of the other gripping element 48 or 46.

In contrast, the spacing for holding containers 34 of a larger diameter (FIG. 6) can be greater in the gripping position. By providing two legs 90, 98, however, such containers 34 can also be reliably held.

The upper gripping members 62, 66 relative to the spacing direction 60 define a common plane in the present case and are configured planar in particular on the top. The container 34 can rest on the gripping members 62, 66 via the finger flange 40 and is thereby reliably held against the gripping elements 46, 48 (FIG. 4) along the spacing direction 60.

It goes without saying that, in the intended use of the gripping device 14, the container 34 is preferably aligned such that the finger flange 40 is arranged on the upper side relative to the direction of gravity.

An exemplary use of the holding apparatus 10 will be discussed below.

The syringes 36 are non stable containers 34 which cannot stand upright on a placement element without additional fixation. When processing the containers 34 in a machine, for example a filling machine, a fixing device 100 can be used for fixing the containers 34 which is shown in FIGS. 4, 7 and 8 in a partial view.

The fixing device 100 has a receiving area 102 for a particular container 34 into which the container 34 can be inserted against the pretension of fixing elements 104 which can be pivoted relative to one another and can be held by means of the fixing elements 104. Even when the container 34 is removed, the fixing elements 104 pivot relative to one another against the pretension.

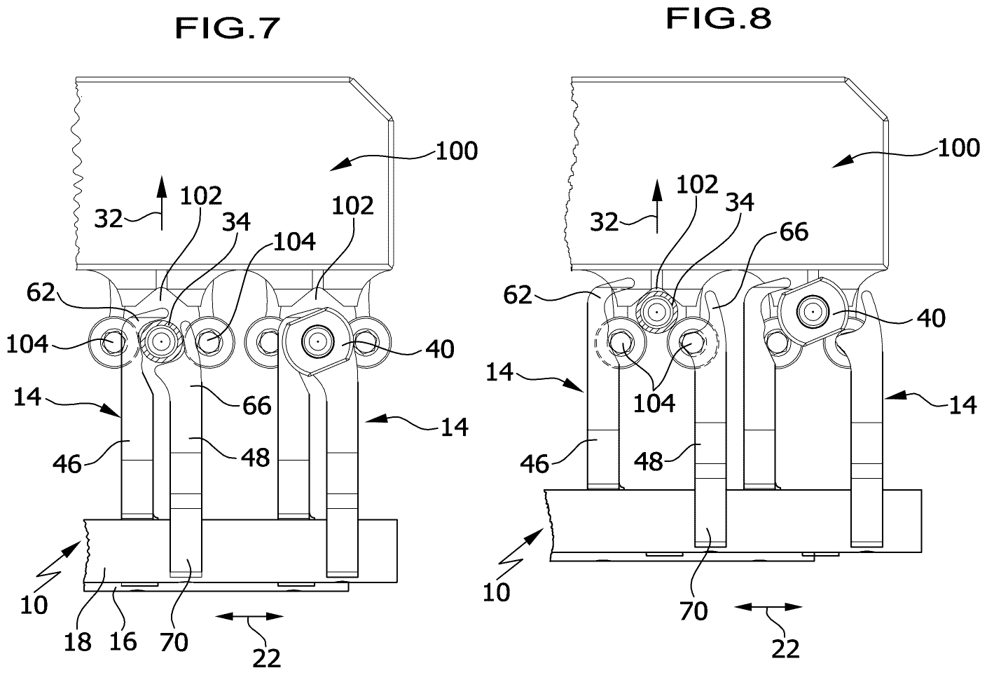

For inserting a container 34 which is held against the gripping elements 46, 48 in their gripping position, the drive unit 24 moves the holding parts 16, 18 in the feed direction 32. When the container contacts the fixing elements 104, these are pivoted relative to one another in order to introduce the container 34 into the receptacle 102 (FIG. 7).

The fixing elements 104 engage in the recess 64 in relation to the spacing direction 60.

A pushing force is exerted on the container 34 via the projection 92 which forms a stop for the container 34.

Because of the two gripping members, 62 on the one hand and 66 on the other hand, which are spaced apart from one another in the spacing direction 60, tilting of the container 34 when inserted into the receptacle 102 can be effectively prevented. This ensures that the container 34 assumes a correct desired position in the gripping device 14 and in the fixing device 100. This increases process reliability.

After the container 34 has been inserted, the holding parts 16, 18 can be moved via the drive unit 24 in such a way that the gripping elements 46, 48 are transferred into the release position and release the container 34 (FIG. 8). The holding parts 16, 18 can then be retracted against the feed direction 32.

Conversely, the procedure can be reversed to remove the container 34 from the fixing device 100.

First, the gripping elements 46, 48 are moved in the release position up to the fixing device 100 in such a way that the gripping elements 46, 48 can be transferred into the gripping position in order to insert the container 34 into the container receptacle 50 (FIG. 8).

The holding parts 16, 18 are then retracted against the feed direction 32 via the drive unit 24.

A tensile force is exerted on the container 34 via the projection 86 forming a stop. In this case as well, two gripping members 62, 66 ensure that the container 34 does not tilt in the container receptacle 50 (FIG. 7) due to the contact with the fixing elements 104 while being pulled out and has a correct target position in the gripping device 14.

The provision of the projection 86, which is only arranged on a gripping element 62, for exerting the tensile force is advantageous. It is found in practice that spreading the gripping elements 46, 48 relative to one another can be prevented during removal of the container 34 from the receptacle 102. The provision of the projection 86, which is only arranged on a gripping element 66, for exerting the pushing force is also advantageous. It is found in practice that spreading the gripping elements 46, 48 relative to one another can be prevented during insertion of the container 34 into the receptacle 102. The process reliability is increased in both cases.

In practice, an embodiment of the gripping members 62, 66 proves to be advantageous in which the projections 86, 92 assume an angle of less than 90° relative to the feed direction 32 (FIGS. 5 and 6). For example, an angle is approximately 80° to 60°, preferably approximately 70°. It is found in practice that the format range of containers 34 can thereby be expanded, which can be held or still be held with the gripping elements 46, 48.

### LIST OF REFERENCE NUMERALS

10 Holding apparatus
12 Transport apparatus
14 Gripping device
16, 18 Holding part
20 Tube
22 Linear direction
24 Drive unit
26 Drive element
28 Coupling element
30 Transport element
31 Control unit
32 Feed direction
34 Container
36 Syringe
38 Syringe body
40 Finger flange
42 Needle guard
44 Container direction
46, 48 Gripping element
50 Container receptacle
52 First face
54 Second face
56 Holding portion
58 Gripping portion
60 Spacing direction
62, 66 Gripping element
64 Recess
68, 72 Transition region
69 Recess
70 Holding member
74 Anti-rotation member
76 Axis
78 Pin
80,82 Opening
84 Free end
86, 92 Projection
88, 96 Lateral support portion
90, 98 Leg
91, 99 Angle
94 Recess
100 Fixing apparatus
102 Receiving area
104 Fixing element
106 Central plane

1. A gripping device for gripping a pharmaceutical container, the gripping device comprising a first gripping element and a second gripping element, each having a gripping member for contacting the pharmaceutical container from opposite sides, wherein the gripping elements receive the pharmaceutical container between one another in a container receptacle and grip the pharmaceutical container in a mutually approximated gripping position, and release the pharmaceutical container in a mutually spaced apart release position, wherein at least one gripping element comprises two gripping members which are mutually spaced apart in a spacing direction, and between which a recess is formed on the gripping element.

2. The gripping device according to claim 1, wherein each gripping element comprises two gripping members which are spaced apart from one another in the spacing direction and between which a recess is formed on the respective gripping element.

3. The gripping device according to claim 1, wherein a gripping member of the first gripping element and a gripping member of the second gripping element are arranged in a same position along the spacing direction.

4. The gripping device according to claim 1, wherein two gripping members arranged in the spacing direction at a same position define a common contact plane and/or are configured planar.

5. The gripping device according to claim 1, wherein the first gripping element comprises two identically configured gripping members, and/or in that the second gripping element comprises two identically configured gripping members.

6. The gripping device according to claim 1, wherein the gripping element comprising at least two gripping members is substantially C-shaped in a side view, at least in portions.

7. The gripping device according to claim 1, wherein the container receptacle comprises a concave recess on the gripping member of at least one gripping element, into which recess the pharmaceutical container engages in the gripping position.

8. The gripping device according to claim 1, wherein the at least one gripping member of the first gripping element and the at least one gripping member of the second gripping element are configured symmetrically to one another relative to a central plane of the gripping device.

9. The gripping device according to claim 1, wherein the at least one gripping member of the first gripping element and the at least one gripping member of the second gripping element in each case substantially have a shape of an L forming the container receptacle with two legs each of which are configured to be abutted against the pharmaceutical container.

10. The gripping device according to claim 9, wherein two legs in each case lie opposite one another at the first gripping element and at the second gripping element.

11. The gripping device according to claim 1, wherein the at least one gripping member of the first gripping element comprises a projection projecting in the direction of the other gripping element at a free end and projects from a lateral support portion of the gripping member.

12. The gripping device according to claim 11, wherein the projection forms a stop for the pharmaceutical container for applying a tensile force.

13. The gripping device according to claim 12, wherein no projection applying a tensile force to the pharmaceutical container is arranged on the second gripping element.

14. The gripping device according to claim 11, wherein the first gripping element is configured plate-shaped, and wherein the projection projects beyond a plane of the gripping element in the direction of the other gripping element.

15. The gripping device according to claim 11, wherein the second gripping element recedes behind the projection at the free end.

16. The gripping device according to claim 11, wherein the projection and the lateral support portion of the gripping member of the first gripping element form an L-shape of the gripping member.

17. The gripping device according to claim 1, wherein the at least one gripping member of the second gripping element comprises a projection projecting in front of a free end in the direction of the other gripping element and a lateral support portion arranged at the free end.

18. The gripping device according to claim 17, wherein the projection forms a stop for the pharmaceutical container for applying a pushing force.

19. The gripping device according to claim 18, wherein no projection applying a pushing force to the pharmaceutical container is arranged on the second gripping element.

20. The gripping device according to claim 17, wherein the second gripping element is configured to be plate-shaped, and that the projection projects beyond a plane of the gripping element in the direction of the other gripping element.

21. The gripping device according to claim 17, wherein a recess is formed on the first gripping element opposite the projection.

22. The gripping device according to claim 17, wherein the projection and the lateral support portion of the gripping member of the second gripping element form an L-shape of the gripping member.

23. The gripping device according to claim 1, wherein the gripping elements each comprise a gripping portion comprising the at least one gripping member and a holding portion via which the gripping element is fixed or fixable on a respective holding part.

24. The gripping device according to claim 23, wherein the holding portions are arranged at different positions relative to the spacing direction and are arranged above one another.

25. A holding apparatus for a pharmaceutical container, the holding apparatus comprising:
at least one gripping device according to claim 1;
a first holding part; and
a second holding part,
wherein the first gripping element is fixed via a holding portion on the first holding part, and the second gripping element is fixed via a holding portion on the second holding part.

26. The holding apparatus according to claim 25, wherein the first gripping element is releasably fixed via a first holding portion on the first holding part, and the second gripping element is releasably fixed via a second holding portion on the second holding part.

27. The holding apparatus according to claim 25, wherein the holding apparatus comprises a plurality of identically configured gripping devices with respective gripping elements fixed to the first holding part and the second holding part.

28. The holding apparatus according to claim 25, wherein the holding apparatus comprises a respective anti-rotation member associated with the gripping element, which is in engagement with the holding part and the gripping element.

29. The holding apparatus according to claim 25, wherein the holding parts are configured to extend longitudinally as tubes or rails.

30. The holding apparatus according to claim 25, wherein the holding apparatus comprises a drive unit via which the holding parts are movable relative to one another in a linear direction, and via which the holding parts are movable together in a direction oriented transverse or perpendicular to the linear direction.
